(19) United States
(12) Patent Application Publication
(10) Pub. No.: US 2020/0019488 A1
(43) Pub. Date: Jan. 16, 2020

(54) Application Test Automate Generation Using Natural Language Processing and Machine Learning

(71) Applicant: SAP SE, Walldorf (DE)

(72) Inventors: Prabhat Kumar Singh, Ranchi (IN); Alex Jude, Ernakulam (IN); Isha Gogia, Bengaluru (IN); Raaj Ahuja, Mumbai (IN)

(21) Appl. No.: 16/034,117

(22) Filed: Jul. 12, 2018

(51) Int. Cl. G06F 11/36; G06N 3/08; G06N 3/04

(52) U.S. Cl. CPC G06F 11/3664; G06N 3/08; G06F 11/3688; G06N 3/0454; G06F 11/3684; G06N 3/0445

(57) ABSTRACT

Data is received that encapsulate a test case document including a series of test instructions written in natural language for testing a software application. The software application includes a plurality of graphical user interface views (e.g., views in a web browser, etc.). Thereafter, the test case document is parsed using at least one natural language processing algorithm. This parsing includes tagging instructions in the test case document with one of a plurality of pre-defined sequence labels. Subsequently, a test automate is generated using at least one machine learning model trained using historical test case documents, corresponding automates, and their successful executions and based on the tagged instructions in the test case document. The generated test automate includes one or more test scripts which, when executed, perform a testing sequence of the software application according to the series of test instructions. Related apparatus, systems, techniques and articles are also described.

### TECHNICAL FIELD

The subject matter described herein relates to techniques for generating test automates for applications having graphical user interfaces by parsing natural language inputs and then automatically generating a corresponding test automate utilizing machine learning.

### BACKGROUND

Applications are utilized to encapsulate increasingly complex various business scenarios requiring sequences of graphical user interface views. To ensure the quality of these business scenarios (as implemented by the applications), such scenarios must be tested before being released to customers. As the costs for fixing a bug after customer release is always higher than prior to release, the quality of the application plays a crucial part in overall product development lifecycle. Currently, teams are testing the quality of their products either manually or through automation tools. Automated testing is preferred over manual testing as it reduces time and effort. Current Automation tools are either record and replay-based or code-based—both of which require significant time and effort to generate corresponding automated test scripts.

### SUMMARY

In a first aspect, data is received that encapsulate a test case document including a series of test instructions written in natural language for testing a software application. The software application includes a plurality of graphical user interface views (e.g., views in a web browser, etc.). Thereafter, the test case document is parsed using at least one natural language processing algorithm. This parsing includes tagging instructions in the test case document with one of a plurality of pre-defined sequence labels. Subsequently, a test automate is generated by parsing the tagged instructions in the test case document and using at least one machine learning model trained using historical test case documents, corresponding automates, and their successful executions (and in some cases the document object model (DOM) of the webpage). The generated test automate includes one or more test scripts which, when executed, perform a testing sequence of the software application according to the series of test instructions.

The at least one machine learning model can be a recurrent neural network trained using a plurality of parsed historical test case documents and their corresponding test automates.

The subject matter described herein can also include execution of the test automate. In some variations, details characterizing performance of the test automate can be logged during execution of the test automate. Further, in some variations, screenshots of the application at various states can be captured during execution of the test automate (which can be based, for example, user preferences).

In some cases, it can be determined, during execution of the test automate, that one of the scripts does not execute properly. At least one machine learning model (different from the earlier referenced machine learning model) can be used to identify an alternate script for the script that does not execute properly. This alternate script can be substituted for the alternate script for the script that does not execute properly. Execution of the test automate can be restarted thereafter using the substituted alternate script. This other machine learning model can similarly be a recurrent neural network trained using a plurality of parsed historical test case documents and/or historical test automates.

The determining can include capturing a document object model (DOM) of the application at the point at which the script does not execute properly. The DOM can be used by the at least one second machine learning model to identify the alternate script.

Non-transitory computer program products (i.e., physically embodied computer program products) are also described that store instructions, which when executed by one or more data processors of one or more computing systems, cause at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The subject matter described herein provides many technical advantages. For example, the current subject matter is advantageous in that a user can quickly generate scripts for testing applications having multiple graphical user interfaces. Such an arrangement is particular helpful as application testers spend a lot of time understanding functional aspects of business scenario, testing tools requires sophisticated understanding in order to effectively utilize them, there is a learning curve involved for testers in understanding and operating testing tool, and testing scripts/protocols require significant amount of time to generate.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a diagram illustrating a natural language test case document;

FIG. 2 is a process flow diagram illustrating the generation and execution of a test automate;

FIG. 3 is a process flow diagram illustrating the generation of a test automate; and

FIG. 4 is a diagram illustrating aspects of a computing device for implementing the current subject matter.

### DETAILED DESCRIPTION

The current subject matter is directed to enhanced techniques for generating test scripts for testing the operability/functionality of an application comprising a series of graphical user interfaces which together, can for example, implement a complex computer-implemented business scenario (a sequence of related GUIs that collectively implement numerous computer implemented business processes). In particular, the current subject matter is directed to the generation of information for testing an application comprising a plurality of graphical user interface views (such testing information is referred to herein as a “test automate”).

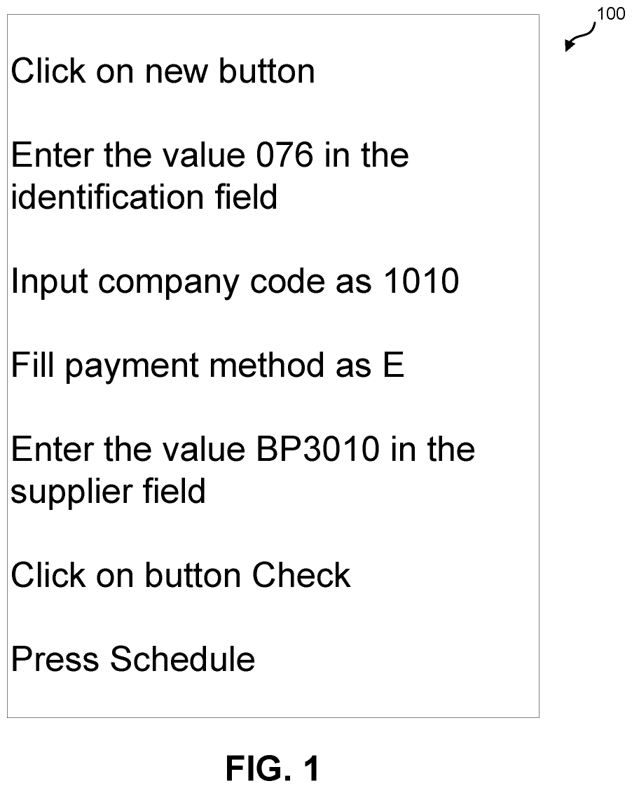

With the current subject matter, a user can generate a test case document such as illustrated in diagram 100 of FIG. 1. As will be noted, rather than being in a specific computer language, the contents of the test case document are in the natural language to which the user is accustomed (i.e., plain free-style English, etc.). It is from this test case document 100 that a corresponding test automate will be generated.

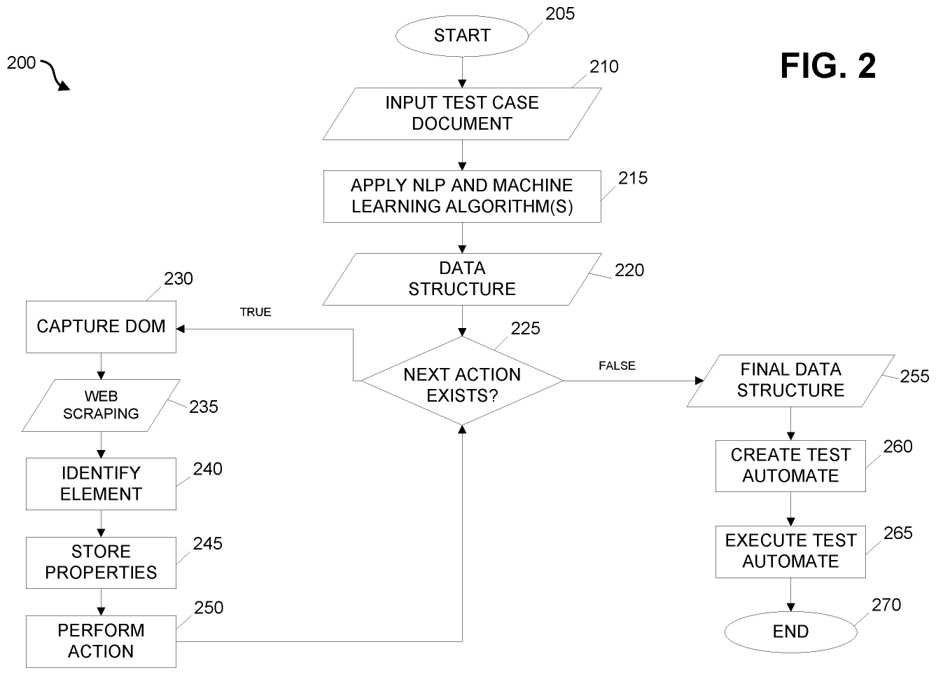

FIG. 2 is a diagram 200 illustrating a process flow for generating a testing automate and executing same. The process commences at 205 in which a test case document (such as the test case document 100 of FIG. 1) is, at 210, inputted, uploaded to, or otherwise accessed by a software-based test automate generation tool. Thereafter, at 215, the test case document is parsed or otherwise characterized using, for example, one or more natural language processing (NLP) algorithms. The natural language processing can, for example, infer meaning from the various commands and tag each item in the test case document with a particular sequence label. These tags can include, for example, Label (e.g., a label for a GUI control, etc.), Value (e.g., a numerical value or any value for a particular aspect of a GUI control, etc.), Action (e.g., an event that occurs upon activation of a GUI control/element, etc.), and Type (i.e., a characterization of the test aspect—element/control). For example, if the test step in the test case document is—“Input 0001 in field Company Code;” then this information is converted, at 215, from a plain English sentence into a 4D structure where LABEL=Company Code, ACTION=Input, VALUE=0001 and TYPE=Input Field.

Once the test case document has been tagged using NLP, the tagged information in the test case document can be input into one or more machine learning models. The machine learning models can, for example, be trained using historical information from a plurality of test case documents and, in some cases, corresponding test automates (i.e., test scripts, etc.). Various types of machine learning models can be used including, for example, neural networks (convolutional neural networks, recurrent neural networks, etc.), random forest, logistic regression, scorecards, support vector machines, and the like. In one implementation, as at 220, the outputs of the NLP algorithm(s) and/or the machine learning model(s) can be saved, step-wise, into an XML document. The XML document (i.e., data structure, etc.) can, for example, be a multi-dimensional data structure (such as a 4-D data structure in cases in which there are four tags).

Thereafter, at 225, the data structure can be iteratively traversed to determine whether a next action exists (actions as tagged by the NLP algorithm). If that is true, then at 230, the application can be launched a complete document object model (DOM) of the page (i.e., the application's webpage which is visible at that particular moment) can be captured (using, for example, JAVA or a different programming language). For example, the application can be executed in a browser launched in header-less mode so that the browser will not be seen and everything happens in the background.

Further, at 235, various information can be scraped from the application as it is rendered from the web browser. Next, at 240, elements can be identified with the DOM that correspond to the particular application. In some cases, machine learning such as deep learning can be used to identify the elements. In particular, with the help of deep learning and the previously created XML (which contains Label, Value, Action and Type), the tool can try to find the best match for the element. If the element cannot be found uniquely using the multi-dimensional (e.g., 4D, etc.) structure of tags, then a deep learning algorithms can be used (which was trained using historical data characterizing previous executions) to find the right element uniquely among the other matches. Properties associated with the identified element can, at 245, then be stored. The properties can, include, for example, one or more of classname, tagname, lsdata, ID, and the like. Thereafter, at 250, the next action can then be performed which, in turn, can cause the DOM to change which requires steps 235-245 to be repeated.

The final data structure 255 is ready once all of the actions have been iterated through. Using this final data structure, at 260, the test automate can be generated. This test automate can now be executed. During execution, the tool can access the generated case automate (which can be in XML) and perform the actions by identifying the element using the properties stored in the test automate. After the execution is complete, a log can be generated with all the details (whether it passed or failed, if failed then failure reason, log category—whether it was a data issue, application issue, or tool Issue) of the steps executed along with associated screenshots. The test automate can use or otherwise include a test plan which can comprise of one or more scripts. These scripts will be able to pass (EXPORT or IMPORT) the values from one script to another for end-to-end scenario execution.

In some implementations, as part of the test automate execution, the current tools can employ self-healing technologies. In particular, if a test script in the test automate fails after few execution attempts at some later point of time because of application or UI issues, then the tool can generate/edit the test scripts without any manual intervention. For example, if the test script fails at step 5 (of a sequence of steps) because of some element property change, then the tool can execute the preceding steps (i.e., steps numbers 1-4) normally and once it reaches step number 5, the tool will capture the DOM of the application at that point. Using deep learning and data captured from the test case document, it will again find the changed element. The tool will then capture the properties of this element and update the test automate accordingly before performing the action. Once the action is performed it will move to the next action and see if the next element's properties have also changed. If changed it will repeat the previous logic to update the automate. This process will heal the test automate.

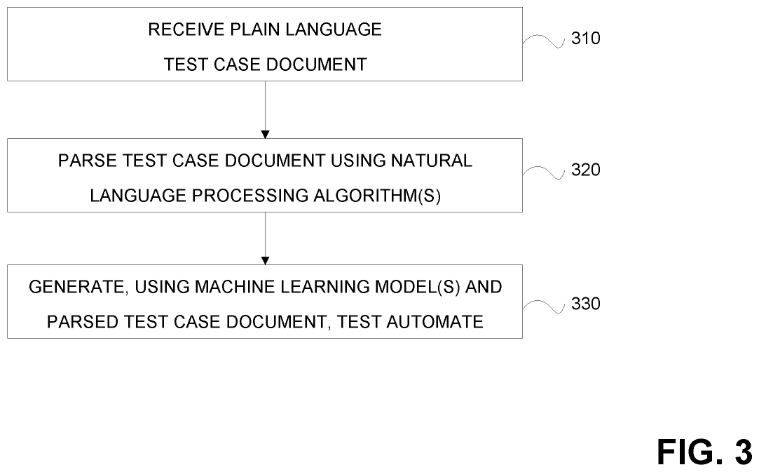

FIG. 3 is a diagram 300 illustrating a process in which, at 310, data is received that encapsulates a test case document. The test case document include a series of test instructions written in natural/plain language for testing a software application comprising a plurality of graphical user interface views. Thereafter, at 320, the test case document is parsed, using at least one natural language processing algorithm, by tagging instructions in the test case document with one of a plurality of pre-defined sequence labels. Subsequently, at 330, a test automate is generated using at least one machine learning model trained using historical test case documents, corresponding historical test automates, and their successful executions (and in some cases the DOM for the webpage in which the application is rendered) and based on the tagged instructions in the test case document. The test automate comprises one or more test scripts which, when executed, perform a testing sequence of the software application according to the series of test instructions.

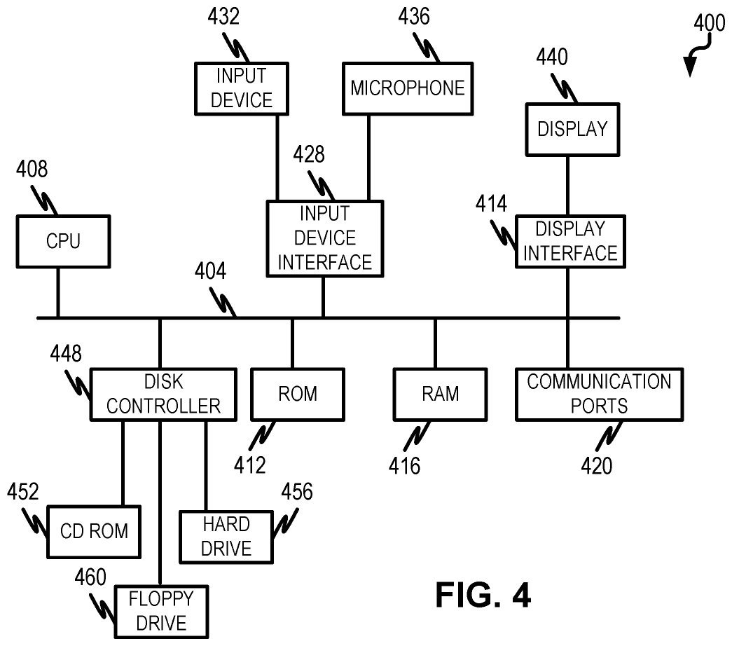

FIG. 4 is a diagram 400 illustrating a sample computing device architecture for implementing various aspects described herein. A bus 404 can serve as the information highway interconnecting the other illustrated components of the hardware. A processing system 408 labeled CPU (central processing unit) (e.g., one or more computer processors/data processors at a given computer or at multiple computers), can perform calculations and logic operations required to execute a program. A non-transitory processor-readable storage medium, such as read only memory (ROM) 412 and random access memory (RAM) 416, can be in communication with the processing system 408 and can include one or more programming instructions for the operations specified here. Optionally, program instructions can be stored on a non-transitory computer-readable storage medium such as a magnetic disk, optical disk, recordable memory device, flash memory, or other physical storage medium.

In one example, a disk controller 448 can interface one or more optional disk drives to the system bus 404. These disk drives can be external or internal floppy disk drives such as 460, external or internal CD-ROM, CD-R, CD-RW or DVD, or solid state drives such as 452, or external or internal hard drives 456. As indicated previously, these various disk drives 452, 456, 460 and disk controllers are optional devices. The system bus 404 can also include at least one communication port 420 to allow for communication with external devices either physically connected to the computing system or available externally through a wired or wireless network. In some cases, the communication port 420 includes or otherwise comprises a network interface.

To provide for interaction with a user, the subject matter described herein can be implemented on a computing device having a display device 440 (e.g., a CRT (cathode ray tube), OLED, or LCD (liquid crystal display) monitor) for displaying information obtained from the bus 404 to the user and an input device 432 such as keyboard and/or a pointing device (e.g., a mouse or a trackball) and/or a touchscreen by which the user can provide input to the computer. Other kinds of input devices 432 can be used to provide for interaction with a user as well; for example, feedback provided to the user can be any form of sensory feedback (e.g., visual feedback, auditory feedback by way of a microphone 436, or tactile feedback); and input from the user can be received in any form, including acoustic, speech, or tactile input. In the input device 432 and the microphone 436 can be coupled to and convey information via the bus 404 by way of an input device interface 428. Other computing devices, such as dedicated servers, can omit one or more of the display 440 and display interface 414, the input device 432, the microphone 436, and input device interface 428.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) and/or a touch screen by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer-implemented method comprising:
receiving data encapsulating a test case document including a series of test instructions written in natural language for testing a software application comprising a plurality of graphical user interface views;
parsing, using at least one natural language processing algorithm, the test case document by tagging instructions in the test case document with one of a plurality of pre-defined sequence labels; and
generating, using at least one machine learning model trained using historical test case documents, corresponding historical test automates, their successful executions, and corresponding document object models (DOMs), a test automate based on the tagged instructions in the test case document, the test automate comprising one or more test scripts which, when executed, perform a testing sequence of the software application according to the series of test instructions.

2. The method of claim 1, wherein the at least one machine learning model is a recurrent neural network trained using a plurality of parsed historical test case documents and their corresponding test automates.

3. The method of claim 1 further comprising: executing the test automate.

4. The method of claim 3 further comprising:
logging, during execution of the test automate, details characterizing performance of the test automate.

5. The method of claim 4 further comprising:
capturing, during execution of the test automate, screenshots of the application at various states.

6. The method of claim 1 further comprising:
determining, during execution of the test automate, that one of a scripts does not execute properly;
identifying, using at least one second machine learning model, an alternate script for the script that does not execute properly;
substituting the alternate script for the script that does not execute properly; and
restarting execution of the test automate using the substituted alternate script.

7. The method of claim 6, wherein the at least one second machine learning model is a recurrent neural network trained using a plurality of historical test automates.

8. The method of claim 7, wherein the determining comprises capturing the document object model (DOM) of the application at the point at which the script does not execute properly, wherein the DOM is used by the at least one second machine learning model to identify the alternate script.

9. The method of claim 1, wherein the application executes in a web browser.

10. The method of claim 1 further comprising:
adaptively modifying the test automate during execution using a self-healing algorithm.

11. A system comprising:
at least one programmable data processor; and
memory storing instructions which, when executed by the at least one programmable data processor, result in operations comprising:
receiving data encapsulating a test case document including a series of test instructions written in natural language for testing a software application comprising a plurality of graphical user interface views;
parsing, using at least one natural language processing algorithm, the test case document by tagging instructions in the test case document with one of a plurality of pre-defined sequence labels; and
generating, using at least one machine learning model trained using historical test case documents, corresponding historical test automates, and their successful executions, a test automate based on the tagged instructions in the test case document, the test automate comprising one or more test scripts which, when executed, perform a testing sequence of the software application according to the series of test instructions.

12. The system of claim 11, wherein the at least one machine learning model is a recurrent neural network trained using a plurality of parsed historical test case documents and their corresponding test automates.

13. The system of claim 11, wherein the operations further comprise:
executing the test automate.

14. The system of claim 13, wherein the operations further comprise:
logging, during execution of the test automate, details characterizing performance of the test automate.

15. The system of claim 14, wherein the operations further comprise:
capturing, during execution of the test automate, screenshots of the application at various states.

16. The system of claim 11, wherein the operations further comprise:
determining, during execution of the test automate, that one of a scripts does not execute properly;
identifying, using at least one second machine learning model, an alternate script for the script that does not execute properly;
substituting the alternate script for the script that does not execute properly; and
restarting execution of the test automate using the substituted alternate script.

17. The system of claim 16, wherein the at least one second machine learning model is a recurrent neural network trained using a plurality of historical test automates.

18. The system of claim 17, wherein the determining comprises capturing a document object model (DOM) of the application at the point at which the script does not execute properly, wherein the DOM is used by the at least one second machine learning model to identify the alternate script.

19. The system of claim 11, wherein the operations further comprise:
adaptively modifying the test automate during execution using a self-healing algorithm.

20. A computer-implemented method comprising:
receiving data encapsulating a test case document including a series of test instructions written in natural language for testing a software application comprising a plurality of graphical user interface views;
generating, using at least one machine learning model trained using historical test information, a test automate based on the tagged instructions in the test case document, the test automate comprising one or more test scripts which, when executed, perform a testing sequence of the software application according to the series of test instructions.
executing the test automate;
adaptively modifying, using at least one second machine learning model trained using historical test automates, the test automate during execution of test automate if an error or failure is detected; and
subsequently initiating execution of the modified test automate.
